(19) United States
(12) Patent Application Publication
(10) Pub. No.: US 2025/0323550 A1
(43) Pub. Date: Oct. 16, 2025

(54) HOUSING FOR MOTOR

(71) Applicant: Hanon Systems, Daejeon (KR)

(72) Inventors: Ji Min LEE, Daejeon (KR); Ho Jun SEO, Daejeon (KR); Cheol HAN, Daejeon (KR)

(73) Assignee: Hanon Systems, Daejeon (KR)

(21) Appl. No.: 19/178,186

(22) Filed: Apr. 14, 2025

(30) Foreign Application Priority Data
Apr. 16, 2024 (KR) 10-2024-0050753

(51) Int. Cl. H02K 5/18

(52) U.S. Cl. CPC H02K 5/18

(57) ABSTRACT

The present invention relates to a housing capable of more effectively dissipating heat generated by a motor, the housing is in contact with a cooling fluid from the outside and may include a motor integrated inside the housing, a substrate integrated inside the housing, an internal heat exchange unit integrated inside the housing and in direct or indirect contact with the motor or the substrate, and a heat dissipation unit in contact with the heat exchange unit inside the housing and in contact with the cooling fluid outside the housing.

### CROSS REFERENCE TO RELATED APPLICATION

The present application claims priority to Korean Patent Application No. 10-2024-0050753, filed on Apr. 16, 2024, the entire contents of which is incorporated herein for all purposes by this reference.

### BACKGROUND OF THE INVENTION

### Field of the Invention

The present invention relates to a housing for a motor, and more particularly, to a housing capable of more effectively dissipating heat generated by the motor.

### Description of the Related Art

Generally, a motor includes a PCB for control and a housing to protect it. Consequently, heat from the motor conducts to the PCB, raising its temperature, but natural cooling is not feasible in a sealed housing structure.

To address this, conventional methods involved cooling by attaching the PCB to the housing via thermal pads to transfer heat outside.

However, this simple contact-based heat dissipation method was insufficient for internal heat generation. Particularly, as motor output increases, heat accumulation in the PCB impairs its function or causes thermal damage, issues that remain unresolved.

### Documents of Related Art

(Patent Document 1) Korean Registered Patent Publication No. 10-1585128

### SUMMARY OF THE INVENTION

The present invention has been conceived to solve the above problems, and it is an object of the present invention to provide a motor housing structure capable of more efficient heat exchange with external cooling fluid.

It is another object of the present invention to provide a motor housing capable of maximizing local heat dissipation efficiency by identifying areas where heat concentrates within the housing.

It is still another object of the present invention to provide a motor housing capable of increasing the flow rate of the cooling fluid in contact without compromising the overall volumetric efficiency of the housing.

A housing in contact with a cooling fluid from the outside according to the present invention may include a motor integrated inside the housing, a substrate integrated inside the housing, an internal heat exchange unit integrated inside the housing and in direct or indirect contact with the motor or the substrate, and a heat dissipation unit in contact with the heat exchange unit inside the housing and in contact with the cooling fluid outside the housing.

In addition, the heat dissipation unit may be formed to protrude outward from the housing and include heat dissipation blades extending in a flow direction of the cooling fluid.

In addition, the heat dissipation blades may include rounded ends at a point where contact with the cooling fluid begins.

In addition, the housing may form a step recessed around a periphery of the heat dissipation blades.

In addition, the heat dissipation blades may be arranged in parallel as a plurality, with cooling flow paths formed between the arranged heat dissipation blades to allow the cooling fluid to pass through, and the step may be recessed to connect with the cooling flow paths.

In addition, the step may be formed at a point where the heat dissipation blades and the cooling fluid begin to make contact.

In addition, the step may further include an inclined portion that gradually decreases in height in the flow direction of the cooling fluid.

In addition, the heat dissipation unit may further include a plurality of heat dissipation fins protruding outward from the housing in a circular shape and distributed across the housing.

In addition, the heat dissipation fins may protrude inward into the housing to facilitate heat exchange between the inside and outside of the housing.

In addition, the heat dissipation fins may be formed at positions where the cooling fluid enters or exits the heat dissipation blades.

In addition, the housing may form a contact portion protruding inward due to the step, and the contact portion is in contact with the internal heat exchange unit.

### BRIEF DESCRIPTION OF THE DRAWINGS

FIG. 1 is a perspective view illustrating the entirety of a motor housing according to an embodiment of the present invention;

FIG. 2 is an exploded perspective view of the motor housing according to an embodiment of the present invention;

FIG. 3 is a top view and enlarged views of the motor housing according to an embodiment of the present invention; and

FIG. 4 is a cross-sectional view of the motor housing according to an embodiment of the present invention.

### DETAILED DESCRIPTION OF THE INVENTION

In the following, the technical aspects of the present invention will be described in more detail with reference to the accompanying drawings. Prior to this, the terms and words used in the following specification and claims should not be construed in a limited sense to their usual or dictionary meanings but should be interpreted according to the meanings and concepts that conform to the technical ideas of the present invention, based on the principle that the inventor can appropriately define the terms to best describe their invention. Therefore, the embodiments described in this specification and the configurations shown in the drawings are merely the most preferred embodiments of the present invention and do not fully represent the technical concept of the present invention, so it should be understood that various modifications and equivalents that can replace them may exist at the time of filing this application.

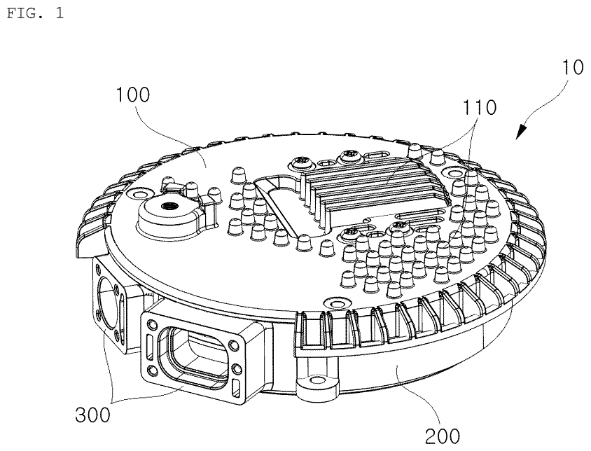

FIG. 1 illustrates the exterior of a housing 10 according to an embodiment of the present invention. The housing 10 may dissipate internal heat to the outside by contacting external cooling fluid. In this embodiment, the housing 10, designed to dissipate heat electrically generated by a motor or a substrate, may include an internal heat exchange unit 220 that is integrated inside the housing and directly or indirectly contacts the motor or the substrate, and a heat dissipation unit 110 that contacts the heat exchange unit inside the housing 10 and contacts the cooling fluid outside the housing 10.

Here, the heat dissipation unit 110 is designed to align with the flow direction of the cooling fluid, maximizing the utilization of the cooling fluid's flow rate, increasing the contact area to the maximum, and generating turbulence above the housing 10, thereby offering the advantage of maximizing heat dissipation efficiency.

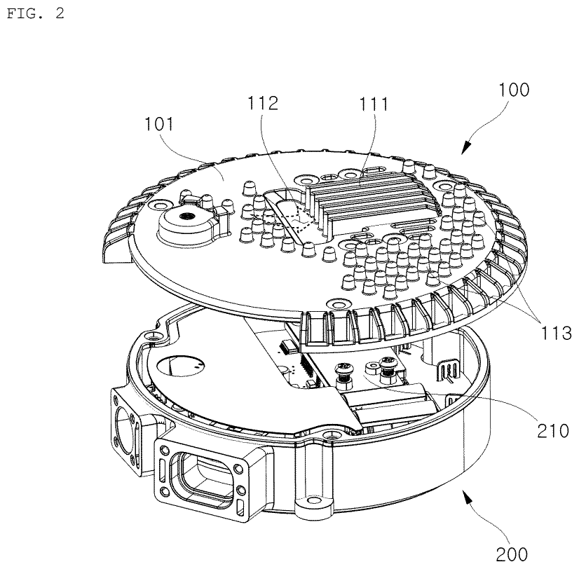

FIG. 2 illustrates an exploded view of a housing 10 according to an embodiment of the present invention. As shown in the drawing, the housing 10 may include an upper housing 100 and a lower housing 200. The upper housing 100 may have a heat dissipation unit 110 formed thereon, while the lower housing 200 may accommodate a substrate for motor operation, an internal heat exchange unit 220, and the like, and may include a connector 300 for electrical connection to the outside.

Here, the heat dissipation unit is formed on the top surface of the housing 10 and may generally include heat dissipation blades 111, a step 112, and heat dissipation fins 113.

In more detail, the heat dissipation unit 110 may protrude outward from the housing 10 and include heat dissipation blades 111 extending in the flow direction of the cooling fluid. As shown in the drawing, the heat dissipation blades 111 may be formed in a plate shape, elongated in the flow direction, and designed as a plurality of blades arranged in a series. That is, flow paths are formed between the plurality of heat dissipation blades 111, allowing the cooling fluid to pass through, and heat exchange may occur with a larger contact area in the flow paths.

In this case, the periphery of the heat dissipation blades and the lower ends of the heat dissipation blades 111 may be recessed below the top surface 101 of the housing 10, forming a step 112. Due to the step 112, the top surface 101 of the housing 10 may be recessed inward, forming a contact portion 112-3 that directly or indirectly contacts the internal heat exchange unit 220, thereby facilitating heat exchange.

Additionally, the heat dissipation unit 110 may include a plurality of heat dissipation fins 113 protruding upward in the form of protrusions from the top surface 101 of the housing 10. The heat dissipation fins 113 may be randomly arranged around the step 112 and the periphery of the heat dissipation blades 111, and may be locally placed in areas with relatively high heat generation. Here, the heat dissipation fins 113 may be arranged in plurality, with their number increasing in the flow direction of the cooling fluid. That is, to prevent a decrease in cooling efficiency due to the heat dissipation fins 113, the heat dissipation fins 113 may be arranged more sparsely at the point where the cooling fluid begins to contact the heat dissipation blades 111.

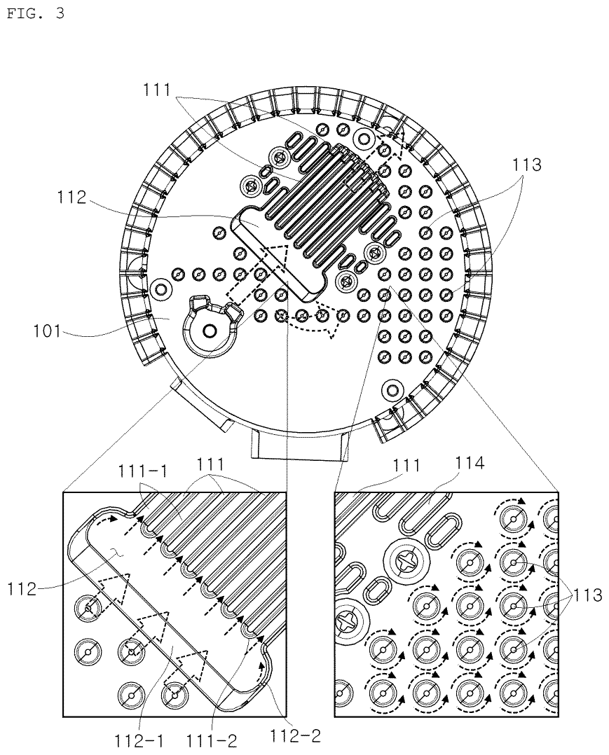

FIG. 3 illustrates the top surface of a housing 10 according to an embodiment of the present invention, along with enlarged views of some areas. As shown in the drawing, the heat dissipation blades are formed to extend in the flow direction of the cooling fluid, arranged in parallel as a plurality, with the periphery and lower ends of the heat dissipation blades 111 recessed below the top surface of the housing 10, forming a step 112.

Here, the step 112 may be formed at the point where the heat dissipation blades 111 and the cooling fluid begin to make contact. For example, the width of the step 112 may be formed wider than the overall width of the heat dissipation blades 111, and the step 112 may include an inclined portion 112-1 that gradually decreases in height from the cooling fluid inlet side toward the heat dissipation blades 111, and streamlined partition walls 112-2 at both ends. That is, the cooling fluid flows down the inclined portion 112-1, gathers in a predetermined space formed by the step 112, and is guided by the partition walls 112-2 to flow into the heat dissipation blades 111.

Here, flow paths 111-1 for the cooling fluid are formed between the plurality of heat dissipation blades 111, and the heat dissipation blades 111 may have rounded ends 111-2 to reduce resistance at the point where contact with the cooling fluid begins.

Additionally, the heat dissipation fins 113 may protrude in a circular shape and be arranged in plurality. Here, the heat dissipation fins 113 are arranged to align with the flow direction of the cooling fluid, but in a zigzag pattern, generating localized turbulence.

The top surface 101 of the housing 10 may further include heat dissipation grooves 114 carved to a predetermined width and depth. As shown in the drawing, the heat dissipation grooves 114 may be formed elongated in the flow direction of the cooling fluid, offering the advantage of allowing the cooling fluid to linger. For example, the heat dissipation grooves 114 may be arranged around the periphery of the heat dissipation blades 111 to dissipate heat from areas not in contact with the heat exchange unit 220. Here, the heat dissipation fins 113 may be designed to taper, with their diameter decreasing upward from the top surface 101 of the housing 10.

For example, the heat dissipation fins 113 may be designed to protrude outward while simultaneously protruding inward into the housing 10. This embodiment allows the heat dissipation fins 113 to increase the contact area with the air inside the housing 10, protruding in the same shape coaxially both externally and internally.

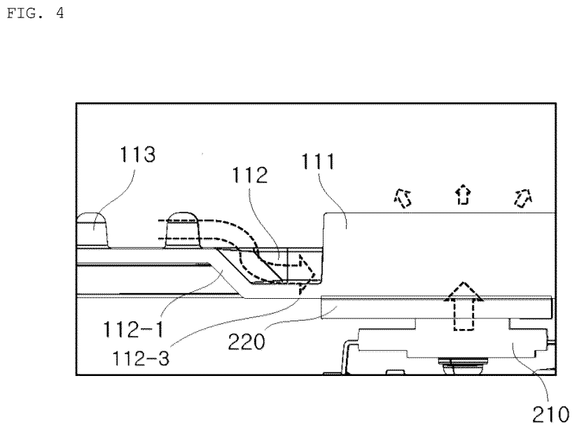

FIG. 4 illustrates a cross-sectional view of a housing 10 according to an embodiment of the present invention. As shown in the drawing, the heat dissipation unit includes a step 112, and the top surface 101 of the housing 10 may be recessed inward into the housing according to the step 112. This allows direct contact with internal components such as a substrate 210 that require heat exchange, and the step 112 forms a predetermined space where cooling fluid can gather, offering the advantage of increasing flow rate. Here, the step 112 may further include an inclined portion 112-1 at the cooling fluid inlet side. The inclined portion 112-1 prevents the cooling fluid from dropping abruptly, forming cavitation, or generating unnecessary turbulence.

Additionally, a heat exchange unit 220 may be interposed and in contact between the lower end of the heat dissipation blades 111 and the substrate 210 to promote heat exchange, with the heat exchange unit 220 typically including a thermal conductive pad or thermal conductive material.

The motor housing according to the present invention is advantageous for achieving high heat dissipation performance by maximizing the contact area with the cooling fluid flowing in a specific direction.

Additionally, the motor housing according to the present invention is advantageous for maximizing local heat dissipation efficiency by identifying areas where heat concentrates.

Furthermore, the motor housing according to the present invention is advantageous for increasing the flow rate of the cooling fluid in contact without increasing the overall volumetric size of the housing.

DESCRIPTION OF REFERENCE NUMERALS

| | |
|---|---|
| 10: housing | |
| 100: upper housing | 101: top surface |
| 110: heat dissipation unit | |
| 111: heat dissipation blades | 111-1: fluid path |
| 111-2: end | |
| 112: step | 112-1: inclined portion |
| 112-2: partition wall | 112-3: contact portion |
| 113: heat dissipation fin | 114: heat dissipation groove |
| 200: lower housing | |
| 210: substrate | |
| 220: heat exchange unit | |
| 300: external connector | |

What is claimed is:

1. A housing in contact with a cooling fluid from the outside, comprising:
a motor integrated inside the housing;
a substrate integrated inside the housing;
an internal heat exchange unit integrated inside the housing and in direct or indirect contact with the motor or the substrate; and
a heat dissipation unit in contact with the heat exchange unit inside the housing and in contact with the cooling fluid outside the housing.

2. The housing of claim 1, wherein the heat dissipation unit is formed to protrude outward from the housing and comprises heat dissipation blades extending in a flow direction of the cooling fluid.

3. The housing of claim 2, wherein the heat dissipation blades comprise rounded ends at a point where contact with the cooling fluid begins.

4. The housing of claim 2, wherein the housing forms a step recessed around a periphery of the heat dissipation blades.

5. The housing of claim 4, wherein the heat dissipation blades are arranged in parallel as a plurality, with cooling flow paths formed between the arranged heat dissipation blades to allow the cooling fluid to pass through, and the step is recessed to connect with the cooling flow paths.

6. The housing of claim 5, wherein the step is formed at a point where the heat dissipation blades and the cooling fluid begin to make contact.

7. The housing of claim 4, wherein the step further comprises an inclined portion that gradually decreases in height in the flow direction of the cooling fluid.

8. The housing of claim 2, wherein the heat dissipation unit further comprises a plurality of heat dissipation fins protruding outward from the housing in a circular shape and distributed across the housing.

9. The housing of claim 8, wherein the heat dissipation fins protrude inward into the housing to facilitate heat exchange between the inside and outside of the housing.

10. The housing of claim 8, wherein the heat dissipation fins are formed at positions where the cooling fluid enters or exits the heat dissipation blades.

11. The housing of claim 4, wherein the housing forms a contact portion protruding inward due to the step, and the contact portion is in contact with the internal heat exchange unit.

12. The housing of claim 6, wherein the heat dissipation blades are formed in a plate shape and arranged at regular intervals.

13. The housing of claim 10, wherein the heat dissipation fins are arranged less densely at the locations where the cooling fluid begins to contact the heat dissipation blades.

14. The housing of claim 8, further including heat dissipation grooves, which are recessed to allow the cooling fluid to remain in contact.

15. The housing of claim 14, wherein the heat dissipation grooves are formed in a plurality around the periphery of the heat dissipation blades.

16. The housing of claim 15, wherein the heat dissipation grooves are disposed between the heat dissipation blades and the heat dissipation fins.
